(19) United States
(12) Patent Application Publication
(10) Pub. No.: US 2016/0071051 A1
(43) Pub. Date: Mar. 10, 2016

(54) SYSTEMS AND METHODS FOR PARCEL REDIRECTION TO A PRIMARY DELIVERY LOCATION

(71) Applicant: United Parcel Service of America, Inc., Atlanta, GA (US)

(72) Inventors: Andy Tibbs, Roswell, GA (US); John Slayton, Brookhaven, GA (US)

(21) Appl. No.: 14/942,757

(22) Filed: Nov. 16, 2015

Related U.S. Application Data
(63) Continuation-in-part of application No. 14/170,298, filed on Jan. 31, 2014.
(60) Provisional application No. 62/080,116, filed on Nov. 14, 2014.
(60) Provisional application No. 61/759,800, filed on Feb. 1, 2013.

(51) Int. Cl. G06Q 10/08

(52) U.S. Cl. CPC G06Q 10/083

(57) ABSTRACT

A system in various embodiments, is configured to redirect one or more parcels from one or more alternate delivery locations to a primary delivery location, which may, for example, include a residence or office of the intended recipient of the one or more parcels. In various embodiments, the system is configured to redirect the parcel in response to a request without further authentication from the intended parcel recipient.

### CROSS REFERENCE TO RELATED APPLICATION

This application is a continuation-in-part of U.S. patent application Ser. No. 14/170,298, filed 31 Jan., 2014, entitled, “Systems and Methods for Parcel Delivery to Alternate Delivery Locations,” which claimed the benefit of priority to U.S. Provisional Patent Application No. 61/759,800, filed Feb. 1, 2013, entitled, “Systems and Methods for Parcel Delivery to Alternate Delivery Locations,” both of which are incorporated herein by reference in their entirety; this application also claims the benefit of U.S. Provisional Application No. 62/080,116, filed 14 Nov., 2014, entitled: “Systems and Methods for Parcel Redirection to a Primary Delivery Location,” which is hereby incorporated by reference in its entirety.

### BACKGROUND

In certain circumstances, a consignee of a particular parcel may arrange to have parcels delivered to a location other than a location associated with the consignee. This may be appropriate, for example, if the consignee will be away from their home or workplace and wishes to pick up the parcel at a convenient, neutral location. However, if circumstances change, the consignee may be forced to travel out of their way to retrieve the parcel from the originally-specified neutral location. Various embodiments described below address this issue.

### SUMMARY

A computer-implemented method of redirecting one or more parcels scheduled for delivery to one or more alternate delivery locations to a primary delivery location, in various embodiments, comprises: (1) receiving, by a processor, an indication that one or more parcels are scheduled for delivery to one or more alternate delivery locations, the one or more parcels having an intended recipient; (2) at least partially in response to receiving the indication, notifying, by a processor, the intended parcel recipient of the one or more scheduled deliveries; (3) receiving from the intended parcel recipient, by a processor, a request to redirect at least one of the one or more parcels to a primary delivery location associated with the intended parcel recipient; (4) at least partially in response to receiving the request, substantially automatically authenticating, by a processor, an authority of the intended parcel recipient to redirect the at least one of the one or more parcels; and (5) at least partially in response to substantially automatically authenticating the intended parcel recipient, substantially automatically facilitating, by a processor, redirection of the at least one of the one or more parcels from the one or more alternate delivery locations to the primary delivery location.

A non-transitory computer-readable medium, in particular embodiments, stores computer executable instructions for: (1) receiving order information associated with a purchase for one or more items made by a user via an online retailer, the order information comprising authenticating information associated with the user; (2) receiving an indication that a parcel containing the one or more items is scheduled for delivery at an alternate delivery location; (3) at least partially in response to receiving the indication, notifying the user of the scheduled delivery; (4) receiving, from the user, a request to redirect the parcel to a primary delivery location; (5) at least partially in response to receiving the request, substantially automatically authenticating the request based at least in part on the authenticating information associated with the user; and (6) at least partially in response to substantially automatically authenticating the request, redirecting the parcel to the primary delivery location.

A computer-implemented method of redirecting a parcel from an alternate delivery location to a primary delivery location, in various embodiments, comprises: (1) receiving, by a processor, an indication that delivery of the parcel is not possible at the primary delivery location; (2) at least partially in response to receiving the indication, retrieving, by a processor, alternate delivery location information associated with the primary delivery location, the alternate delivery location information comprising information selected from a group consisting of: (i) one or more parcel recipient alternate delivery preferences; and (ii) one or more parcel shipper alternate delivery preferences; (3) determining, based at least in part on the alternate delivery location information, a suitable alternate delivery location; (4) redirecting, by a processor, the parcel from the primary delivery location to the suitable alternate delivery location; (5) notifying, by a processor, an intended parcel recipient of the redirection of the parcel to the suitable alternate delivery location; (6) at least partially in response to the notification, receiving, by a processor, a request from the intended parcel recipient to re-redirect the parcel to the primary delivery location; (7) at least partially in response to the request, substantially automatically authenticating the request; and (8) at least partially in response to substantially automatically authenticating the request, re-redirecting the parcel to the primary delivery location.

### BRIEF DESCRIPTION OF THE DRAWINGS

Various embodiments of a system and method for redirecting one or more parcels from an alternate delivery location to a primary delivery location are described below. In the course of this description, reference will be made to the accompanying drawings, which are not necessarily drawn to scale, and wherein:

FIG. 1 is a block diagram of a parcel redirection system in accordance with an embodiment of the present system;

FIG. 2 is a schematic diagram of a computer, such as the logistics server of FIG. 1, that is suitable for use in various embodiments;

FIG. 3 depicts a flow chart that generally illustrates various steps executed by a parcel redirection to a primary delivery location module that, for example, may be executed by the logistics server of FIG. 1;

FIGS. 4-6 are transportation diagrams depicting exemplary transportation paths taken by packages that are delivered to alternate delivery locations.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In particular embodiments, a system for redirecting parcels from alternate delivery locations to a primary delivery address (e.g., a residential or home address or a business or work address) associated with an intended parcel recipient is configured to facilitate the delivery of one or more parcels destined for one or more alternate delivery locations (e.g., via a common carrier, logistics company, etc.). In particular embodiments, an alternate delivery location may include a location other than the primary delivery address of a parcel's intended recipient. In various embodiments, these alternate delivery locations include retail stores (e.g., including gas stations, grocery stores, and pharmacies), stand-alone kiosks, or any other suitable location for receiving and holding parcels for pick up by recipients. In various embodiments, a user may select to have one or more parcels shipped substantially directly to such an alternate delivery location when initiating a shipment of a parcel (e.g., when the user is purchasing one or more items from an e-commerce site, etc.). The user may then desire to redirect a parcel containing the one or more items to a primary delivery address (e.g., the user's home address or office) for any suitable reason. The user may, for example, have selected an alternate delivery location for a parcel scheduled for delivery on a Wednesday near a location that was convenient to a location where the user had a meeting scheduled. The user may then desire to redirect the parcel to the user's home address due, for example, to a cancellation of their Wednesday meeting.

In another embodiment, a parcel originally scheduled for delivery to a primary delivery location (e.g., such as the recipient's residence) may be redirected to an alternate delivery location. In particular embodiments, the redirection of the parcel to an alternate delivery location occurs at least partially in response to a determination that delivery of the parcel to the primary delivery location is not possible (e.g., because the recipient is not home when an attempt is made to deliver the parcel, the parcel requires a signature, the person delivering the parcel determines that it would be unsafe to leave the parcel outside of the primary delivery location, or for any other suitable reason). In other embodiments, the redirection of the parcel to an alternate delivery location occurs at least partially in response to a request from the parcel recipient to redirect the parcel. As a particular example, when the recipient is notified via a service such as the My Choice service offered by UPS of Atlanta, Ga. that the recipient has a parcel scheduled for delivery, the recipient may elect to have the parcel delivered to an alternate delivery location instead of the scheduled delivery address. In various embodiments, the system is configured to enable the user to redirect the parcel to a primary delivery location following an initial redirection (e.g., by the system) of the parcel to an alternate delivery location.

In particular embodiments, the system is configured to enable a user to redirect the parcel to a primary delivery location substantially without requiring the user to provide further authentication. For example, the system may be configured to substantially automatically facilitate redirection of the parcel from an alternate delivery location to a primary delivery location by: (1) notifying an intended parcel recipient of a scheduled delivery to the alternate delivery location; (2) receiving, from the intended parcel recipient, at least partially in response to the notification, a request to redirect the parcel to the primary delivery location; and (3) at least partially in response to the request, substantially automatically facilitating redirection of the parcel to the primary delivery location.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

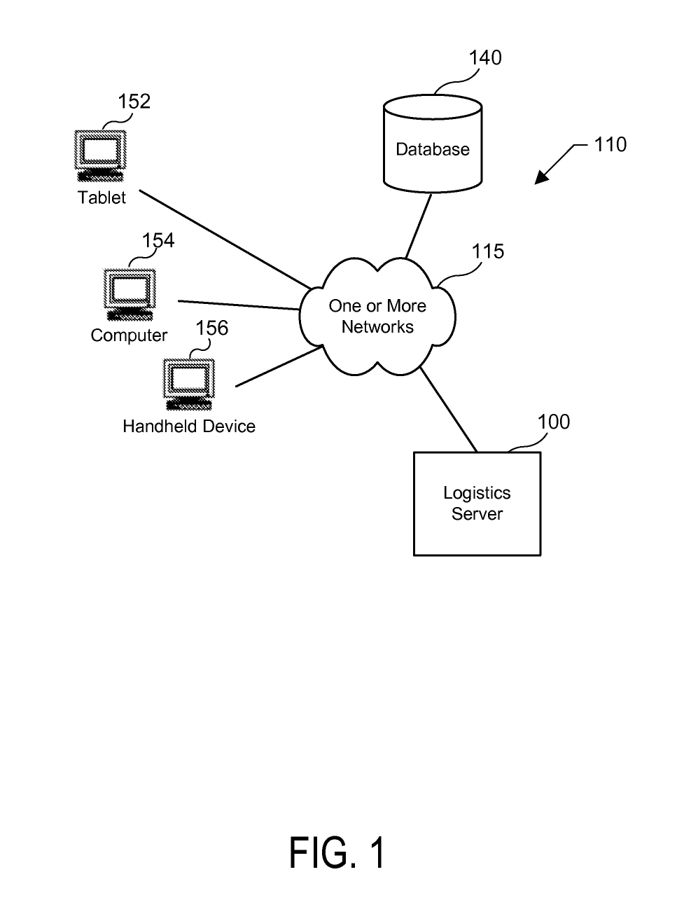

FIG. 1 is a block diagram of a System 110 according to a particular embodiment. As may be understood from this figure, the System 110 includes one or more computer networks 115, a Logistics Server 100, a Database 140, and one or more remote computing devices such as a tablet computer 152, a desktop or laptop computer 154, or a handheld computing device 156, such as a cellular phone. In particular embodiments, the one or more computer networks facilitate communication between the Logistics Server 100, Database 140, and one or more remote computing devices 152, 154, 156.

One or more computer networks 115 may include any of a variety of types of wired or wireless computer networks such as the Internet, a private intranet, a public switch telephone network (PSTN), or any other type of network. The communication link between Logistics Server 100 and Database 140 may be, for example, implemented via a Local Area Network (LAN) or via the Internet.

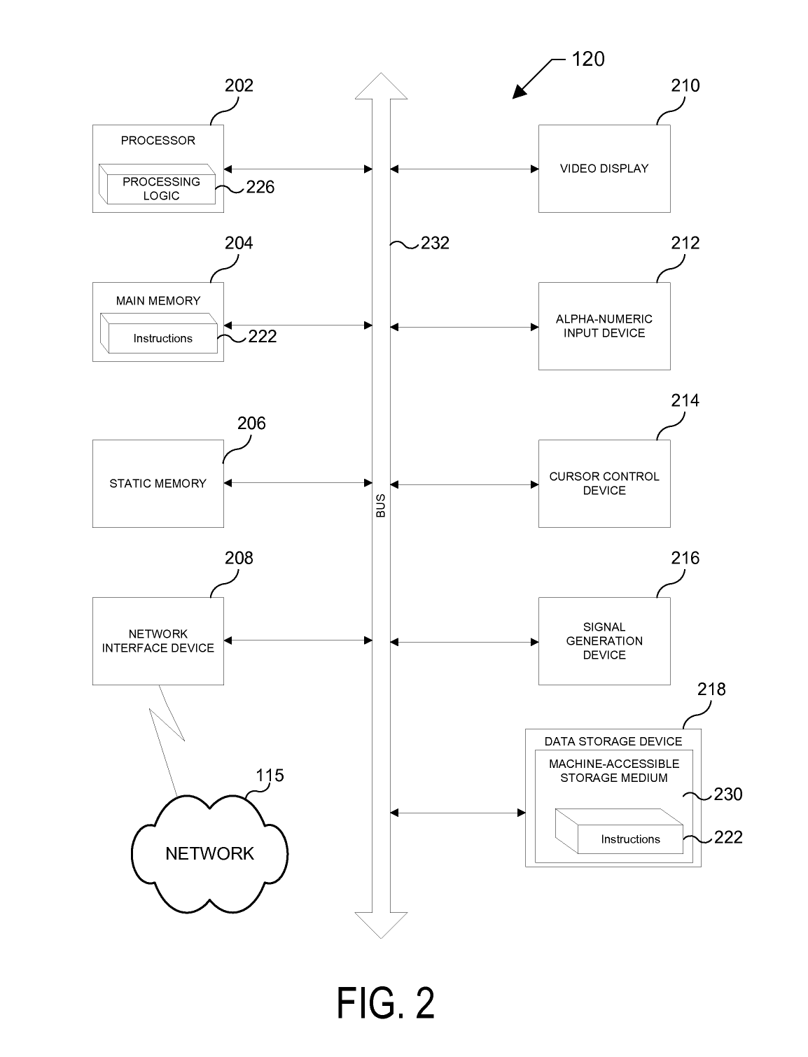

FIG. 2 illustrates a diagrammatic representation of a computer architecture 120 that can be used within the System 110, for example, as a client computer (e.g., one of client computers 152, 154, 156 shown in FIG. 1), or as a server computer (e.g., Logistics Server 100 shown in FIG. 1). In particular embodiments, the computer 120 may be suitable for use as a computer within the context of the System 110 that is configured to facilitate the delivery of parcels to alternate delivery locations or facilitate the receipt and/or processing of parcels once they are delivered to the alternate delivery locations.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within main memory 204 and/or within processing device 202 during execution thereof by computer 120—main memory 204 and processing device 202 also constituting computer-accessible storage media. The software 222 may further be transmitted or received over a network 220 via network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary System Platform

Various embodiments of a system for redirecting parcels from one or more alternate delivery locations to a primary delivery location may be implemented within the context of any suitable service. For example, particular embodiments may be implemented within the context of any service offered by UPS of Atlanta, Ga. Various aspects of the system's functionality may be executed by certain system modules, including a Parcel Redirection Primary Delivery Location Module 300. This module is discussed in greater detail below.

Parcel Redirection to Primary Delivery Location Module

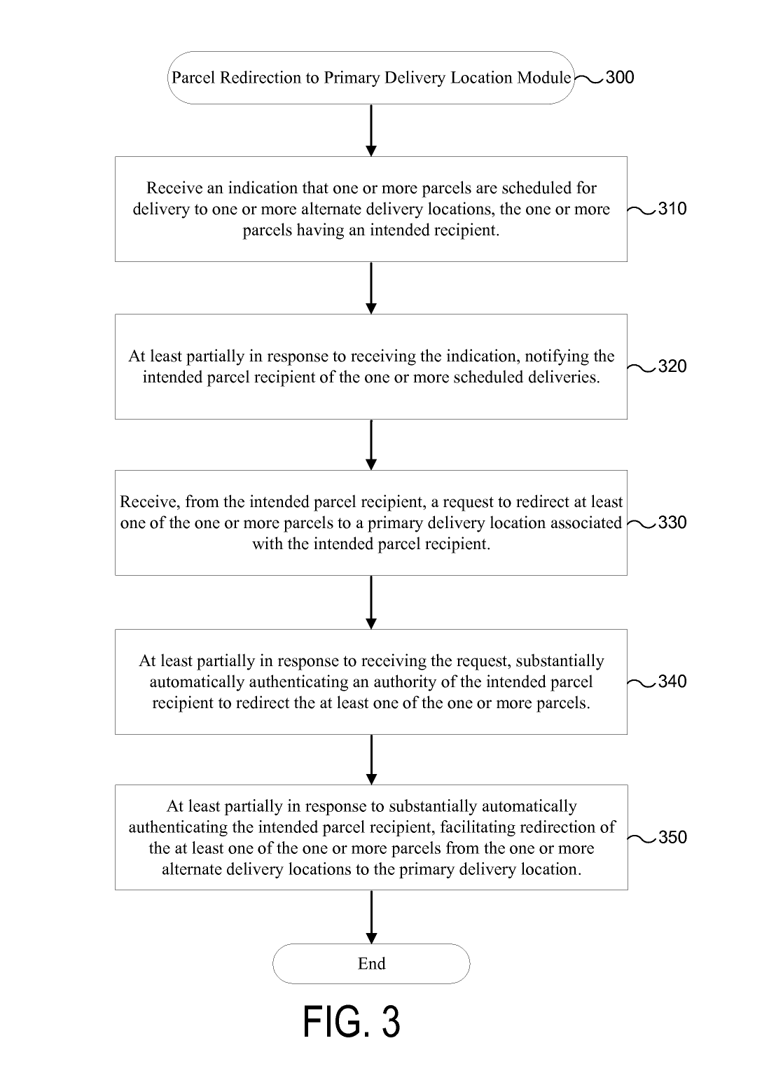

FIG. 3 is a flow chart of operations performed by an exemplary Parcel Redirection to Primary Delivery Location Module 300. In particular embodiments, the Parcel Redirection to Primary Delivery Location Module 300 may facilitate the redirection of one or more parcels from one or more alternate delivery locations to a primary delivery location (e.g., such as the parcel recipient's residence or other address associated with the parcel recipient).

When executing the Parcel Redirection to Primary Delivery Location Module 300, the system begins, at Step 310, by receiving an indication that one or more parcels are scheduled for delivery to one or more alternate delivery locations, the one or more parcels having an intended recipient. In particular embodiments, the system may receive the indication at least partially in response to an initiation of a shipment of one or more parcels by an individual, where the shipment of one or more parcels are addressed to the intended recipient via the one or more alternate delivery locations. For example, an individual may ship a parcel to a friend or relative by shipping the parcel to an alternate delivery location rather than a primary delivery address of the intended recipient (e.g., the intended recipient's work or home address). An individual may elect to ship the parcel to the alternate delivery location for any suitable reason, such as, for example, at the request of the intended parcel recipient, based on a knowledge that the intended parcel recipient is travelling (e.g., may be in a location other than near their primary delivery location) when the parcel would be scheduled to arrive, etc. In an illustrative example, a mother may ship a birthday present intended for her son to an alternate delivery location near a hotel at which the son is scheduled to stay in New York during a business trip on his birthday.

In other embodiments, the system may receive the indication at least partially in response to a purchase made by a user of an e-commerce website or other online retailer, where the user requests the purchase to be delivered to an alternate delivery location. In various embodiments, businesses may provide customers with the option of having items scheduled for shipment to those customers (e.g., items purchased by those customers) shipped directly to alternate delivery locations, rather than having the items shipped to the customer's home or office. In such embodiments, the businesses may provide a selection of alternate delivery locations to which the customer may send shipments. In other embodiments, the alternate delivery locations may be supplied by the common carrier that coordinates the shipment of the item. For example, a common carrier such as UPS may have particular alternate delivery locations associated with the common carrier in a particular city (e.g., such as Atlanta, Ga.). A customer ordering an item for shipment to that particular city may, when ordering the item, be presented with a listing of the particular alternate delivery locations associated with the common carrier. In various embodiments, the system receives the indication when the online retailer or other business initiates shipment of any purchased item to the alternate delivery location selected by the user. In various embodiments, the system is further configured to receive authenticating information associated with the user placing the order such as, for example, a home or office address of the user, a phone number, an e-mail address, or any other contact information associated with the user, etc. In various embodiments, the system may receive information associated with a computing device from which the user placed the order, such as, for example, an IP address, MAC address, etc.

In still other embodiments, the system may receive the indication at least partially in response to redirection, by the system, of the one or more parcels from a first delivery location to the one or more alternate delivery locations. For example, the system may have scheduled delivery of the one or more parcels to the one or more alternate delivery locations at least partially in response to determining that delivery of the one or more parcels to the first delivery location was not possible. In particular embodiments, the first delivery location may include a primary delivery location (e.g., home or work address) associated with the intended parcel recipient.

In particular embodiments, the intended recipient may have one or more accounts associated with one or more common carriers, such as, for example, an account for the My Choice service offered by UPS of Atlanta, Ga. In particular embodiments, the system may store (e.g., in one or more suitable data stores) and/or retrieve information associated with the intended parcel recipient such as, for example, contact information (e.g., one or more e-mail addresses, one or more phone numbers, etc.), primary address information (e.g., home address, work address, etc.), or any other suitable information associated with the intended parcel recipient. In various embodiments, the information is associated with the intended parcel recipient's one or more accounts with the one or more common carriers.

In some embodiments, an intended parcel recipient may, at any particular time, have a plurality of parcels for which they are the intended recipient that are currently scheduled for delivery to one or more alternate delivery locations. In some embodiments, the one or more alternate delivery locations may include, for example, a plurality of different alternate delivery locations which may, for example, be located in a plurality of different places (e.g., different parts of a city, or even different cities altogether).

The system continues, at Step 320, by, at least partially in response to receiving the indication, notifying the parcel recipient of the one or more scheduled deliveries. In various embodiments, the system is configured to notify the intended parcel recipient using any contact information associated with the intended parcel recipient, such as, for example, contact information associated with an account associated with a common carrier, contact information provided by a shipper of the one or more parcels, etc. In particular embodiments, the system is configured to notify the intended parcel recipient of the one or more scheduled deliveries via, for example, e-mail, SMS or other text message, a message sent to the intended parcel recipient's account associated with the common carrier, or in any other suitable manner.

In some embodiments, the notification may include, for example, information associated with an estimated delivery time of the one or more parcels, information associated with a shipper of the one or more parcels, information associated with the one or more alternate delivery locations to which the one or more parcels are scheduled for delivery (e.g., such as an address, operating hours, etc.), tracking information associated with the one or more parcels, etc.

In particular embodiments, the system is further configured, at Step 330, for receiving a request from the intended parcel recipient to redirect at least one of the one or more parcels from the one or more alternate delivery locations to a primary address associated with the intended parcel recipient. In various embodiments, the system is configured to receive the request at least partially in response to the notification of the scheduled delivery sent to the intended recipient at Step 320. In particular embodiments, the request includes the primary address. In other embodiments, the system is configured to retrieve the primary address associated with the intended recipient in response to the request. In particular embodiments, the system may receive the request, for example, via e-mail, via phone, via text message, via the intended recipient's account associated with a common carrier, or in any other suitable manner.

In particular embodiments, the request is a request to redirect all parcels scheduled for delivery at a particular alternate delivery location to a primary delivery location. For example, an intended parcel recipient may have three parcels scheduled for delivery at a gas station near their office and two parcels scheduled for delivery at the grocery store by their home. The intended recipient may redirect the parcels scheduled for delivery to the gas station by their office to their home address, for example, because they are working from home for a few days and will not be able to retrieve the parcels, or for any other suitable reason. In other embodiments, the request includes a request to redirect all parcels scheduled for delivery at any alternate delivery location with the intended recipient as the intended recipient to a primary address associated with the intended recipient. In still other embodiments, the request may include a request to redirect any suitable combination of the one or more parcels scheduled for delivery at any of one or more alternate delivery locations.

In various embodiments, the system may receive the request for any suitable reason. An intended parcel recipient may, for example, realize that an alternate delivery location selected for delivery of a parcel is no longer convenient (e.g., due to one or more external circumstances such as the intended recipient's work or personal schedule, illness, injury, car trouble, etc.). In some embodiments, the intended parcel recipient may wish to redirect one or more parcels to their primary delivery location in response to a substantially automatic redirection of the one or more parcels, by the system, from their primary delivery location to an alternate delivery location (e.g., such as in the case of a parcel that the system has determined is undeliverable at the primary delivery location). As an illustrative example, the system may determine that delivery of a parcel is not possible at a primary delivery location. The system may then redirect the parcel to an alternate delivery location, for example, substantially automatically, at the direction of the intended parcel recipient, or in any other suitable manner, such as in any manner in U.S. patent application Ser. No. 14/170,298, filed 31 Jan., 2014, entitled, “Systems and Methods for Parcel Delivery to Alternate Delivery Locations,” which is hereby incorporated by reference in its entirety. The intended recipient may later request that the system re-redirect the parcel back to the primary delivery location and provide authorization for the common carrier to leave the parcel despite any reason for which the parcel was originally determined to be undeliverable (e.g., due to a signature requirement, special handling instruction, etc.).

Returning to FIG. 3, the system continues, at Step 340, by, at least partially in response to receiving the request, substantially automatically (e.g., automatically) authenticating an authority of the intended parcel recipient to redirect the at least one of the one or more parcels. In various embodiments, the system is configured to enable the intended parcel recipient to request redirection of the parcel without further authentication. For example, the system may facilitate the redirection in response to the request substantially automatically without requiring the intended parcel recipient to provide any password, without requiring the intended recipient to confirm their identity, or without requiring the intended parcel recipient to take any other authenticating action.

In various embodiments, the system may, for example, substantially automatically authenticate the authority of the intended recipient to redirect the at least one of the one or more parcels based at least in part on a source of the request received at Step 330. In particular embodiments, the system may: (1) receive the request to redirect the parcel at Step 330; (2) determine a source of the request; (3) determine whether the source of the request is associated with the intended parcel recipient; and (4) at least partially in response to determining that the source of the request is associated with the intended parcel recipient, substantially automatically authenticate the authority of the intended parcel recipient to redirect that at least one of the one or more parcels. For example, the system may authenticate the request based at least in part on receiving the request from a phone number associated with the intended recipient (e.g., via text message, SMS, phone call, etc.), from a computing device associated with the intended recipient (e.g., based at least in part on an IP address, MAC address, etc. of the computing device from which the system received the request), from an e-mail address associated with the intended recipient, from an account associated with the intended recipient with the common carrier facilitating delivery of the parcel, from a computing device on which the intended recipient is logged into their account associated with the common carrier, or in any other suitable manner.

In one embodiment, the system is configured for: (1) receiving the request from a computing device (e.g., smartphone, tablet, desktop computing device, etc.); (2) determining whether the computing device is substantially currently logged into the intended parcel recipient account associated with the common carrier; and (3) at least partially in response to determining the computing device is substantially currently logged into the intended parcel recipient account, substantially automatically authenticating the request. In various embodiments, the system is configured to determine that the computing device is substantially currently logged into the intended parcel recipient account based at least in part on one or more cookies. In other embodiments, the system is configured to determine that the computing device is substantially currently logged into the intended parcel recipient account based at least in part on an IP address of the computing device and an IP address from which the intended parcel recipient account was most recently accessed.

In particular embodiments, the system is configured to substantially automatically authenticate the request based at least in part on receiving the request in response to the notification provided to the intended recipient at Step 320. The system may, for example, substantially automatically authenticate the request when the request is received as a reply to an SMS, e-mail or other notification sent to the intended recipient (e.g., sent to the intended recipient from the common carrier to notify the intended recipient of the scheduled delivery to the one or more alternate delivery locations).

In other embodiments, the system may be configured to: (1) determine a source of the request; (2) determine whether the source of the request is associated with the intended parcel recipient; and (3) at least partially in response to determining that the source of the request is associated with the intended parcel recipient, substantially automatically authenticate the request. For example, the system may receive the request as a text message from a particular phone number and determine whether the phone number is associated with the intended parcel recipient. In other embodiments, the request may comprise an e-mail, and the system may determine that the e-mail address from which the e-mail was received is associated with the intended recipient. In particular embodiments, the system is configured to determine whether the source of the request is associated with the intended parcel recipient based on information provided to the system by the intended recipient (e.g., when the user signed up for the intended parcel recipient account). The intended recipient may have, for example, previously provided contact information such as a telephone number, e-mail address, etc. to the system, which the system may use to determine whether the source of the request is associated with the intended parcel recipient.

In other embodiments, in which the intended parcel recipient has not provided contact information to the system, the system may determine whether the source of the request is associated with the intended parcel recipient based at least in part on, for example, publicly available information such as one or more phone directories, social networking information, etc. For example, an intended parcel recipient may have a public social network account (e.g., on Twitter, Facebook, LinkedIn, or any other suitable social network) that is associated with an e-mail address, phone number, or other contact information. The system may: (1) receive information associated with a social network account of the intended parcel recipient; (2) determine, from the social network information, an e-mail address and/or telephone number for the intended parcel recipient; and (3) use the determined email address and/or telephone number to determine whether the source of the request is associated with the intended parcel recipient.

In embodiments in which the intended parcel recipient has ordered one or more items from an online retailer and initially requested delivery to an alternate delivery location, the system may, in various embodiments, receive authenticating information from the intended parcel recipient as part of the order. The authenticating information may, for example, include an IP or MAC address for the computing device from which the intended parcel recipient placed the order, contact information for the intended parcel recipient, etc.

In particular embodiments, the system may be configured to facilitate payment, by the intended parcel recipient for the redirection. The system may, for example, determine, based at least in part on a distance between the alternate delivery location and the primary delivery location, an amount of progress made in the delivery of the parcel to the alternate delivery location, or any other suitable factor, and a charge for redirecting the parcel to the primary delivery location. For example, the system may determine a cost that is higher for a redirection of a greater distance or to a different city or state. In various embodiments, the system may notify the intended parcel recipient of the charge and enable the intended parcel recipient to provide payment (e.g., via credit card, etc.) or cancel the request.

Returning to Step 350, the system continues by, at least partially in response to substantially automatically authenticating the intended parcel recipient, facilitating redirection of the at least one of the one or more parcels from the one or more alternate delivery locations to the primary delivery location. In various embodiments, facilitating the redirection comprises notifying one or more delivery drivers of the delivery change. In other embodiments, the system is configured to provide updated tracking information to the intended recipient for the at least one of the one or more parcels. In other embodiments, the system is configured to notify the intended recipient that the redirection has been initiated (e.g., that their request has been accepted). In particular embodiments, the system is configured to notify the parcel recipient that the parcel has been delivered to the primary delivery location (e.g., via e-mail, SMS, text message, or any other suitable method of communication).

### Alternate Embodiments

### Substantially Automatic Redirection to a Primary Delivery Location

In various embodiments, the system is configured to substantially automatically redirect one or more parcels having an intended recipient from an alternate delivery location to a primary delivery location associated with the intended parcel recipient. The system may, for example, receive information associated with a location of the intended parcel recipient (e.g., a GPS location determined from a mobile computing device associated with the intended parcel recipient, such as a smartphone) on a day when the system is facilitating delivery of the one or more parcels to the alternate delivery location. For example, the system may determine that the intended parcel recipient has not travelled to work (e.g., is still located at their home due to illness or for any other suitable reason) on the day on which delivery of the one or more parcels is scheduled, where the one or more parcels were originally scheduled for delivery to an alternate delivery location convenient to the intended recipient's office. In response to making this determination, the system may, in various embodiments, substantially automatically redirect the parcel from the alternate delivery location for which delivery was scheduled to the home of the intended parcel recipient. In some embodiments, this substantially automatic redirection may enable the intended recipient to receive their one or more parcels sooner.

In other embodiments, the system may receive information associated with a calendar associated with the intended parcel recipient, which may, for example, include one or more appointments scheduled by the intended parcel recipient and a location of the one or more appointments. The system may, for example, determine that an appointment that the intended parcel recipient had scheduled at a location convenient to a first alternate delivery location on a day on which a parcel is scheduled for delivery to the first alternate delivery location has been removed from the intended recipient's calendar. In response to making this determination, the system may, in various embodiments, substantially automatically redirect the parcel from the first alternate delivery location to the primary delivery location of the intended parcel recipient. This redirection may, in various embodiments, enable the intended recipient to avoid having to make a trip to the first alternate delivery location, which may, for example, be out of the way or inconvenient if it is no longer convenient to a location that the intended recipient had already planned to be at according to the intended recipient's calendar.

In still other embodiments, the system may enable the intended parcel recipient to provide one or more preferences that any parcels having the intended recipient as the intended recipient should always be delivered to the intended recipient's primary address. In such embodiments, the system is configured to: (1) receive the one or more preferences from the intended recipient; (2) determine that a parcel is scheduled for delivery to a location other than the intended recipient's primary delivery location; (2) at least partially in response to determining that the parcel is scheduled for delivery to the non-primary delivery location, substantially automatically redirect the parcel to the primary delivery location and facilitate delivery of the parcel to the primary delivery location.

### Illustrative Examples

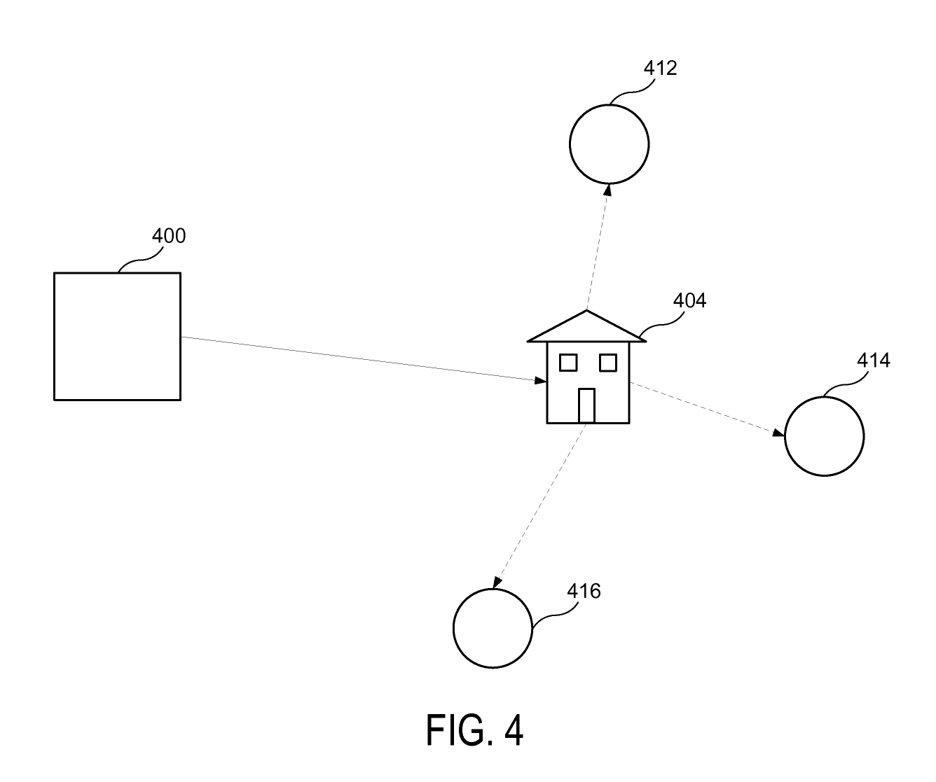

FIG. 4 shows an exemplary transportation diagram that generally illustrates the redirection of a delivery from a primary delivery location to an alternate delivery location. As shown in this figure, a parcel 400 may be delivered from any suitable starting point (e.g., such as a local distribution center, retailer, warehouse, etc.) to a primary delivery location 404 (e.g., such as a residence, office, etc.). If it is not possible to deliver the parcel 400 to the primary delivery location 404, the system will redirect the parcel to an alternate delivery location 412, 414, 416. The alternate delivery locations may include, for example, gas stations, grocery stores, pharmacies, stand-alone kiosks, or any other suitable location for receiving and holding parcels for pick up by recipients.

In various embodiments, a system for directing parcels to alternate delivery locations will determine the most suitable alternate delivery location to which the parcel should be delivered. In the example shown in FIG. 4, the parcel recipient may have provided the parcel carrier (e.g., the company responsible for delivering the parcel to the recipient) with an ordered list of preferred alternate delivery locations, such as a preference for alternate delivery locations A, B, and C in that order. The system, when determining the most suitable alternate delivery location for the undeliverable parcel, may determine which alternate delivery location is most preferable to the parcel recipient that also has availability to receive and hold the parcel until the recipient can pick the parcel up from the alternate delivery location. If, for example, alternate delivery location A 412 is completely full and cannot accept any more parcels, but alternate delivery location B 414 has space to receive the parcel 400, the system would determine that alternate delivery location B 414 is the most suitable alternate delivery location. The system may then redirect the parcel to alternate delivery location B 414. In various embodiments, the system is configured to substantially automatically reserve space for the parcel 400 at the alternate delivery location determined to be most suitable (e.g., in this case, the system would reserve space for the parcel at alternate delivery location B 414). In such embodiments, reserving space may avoid a problem where an alternate delivery location was determined to have availability, but when the parcel finally reached the alternate delivery location, there was no longer availability.

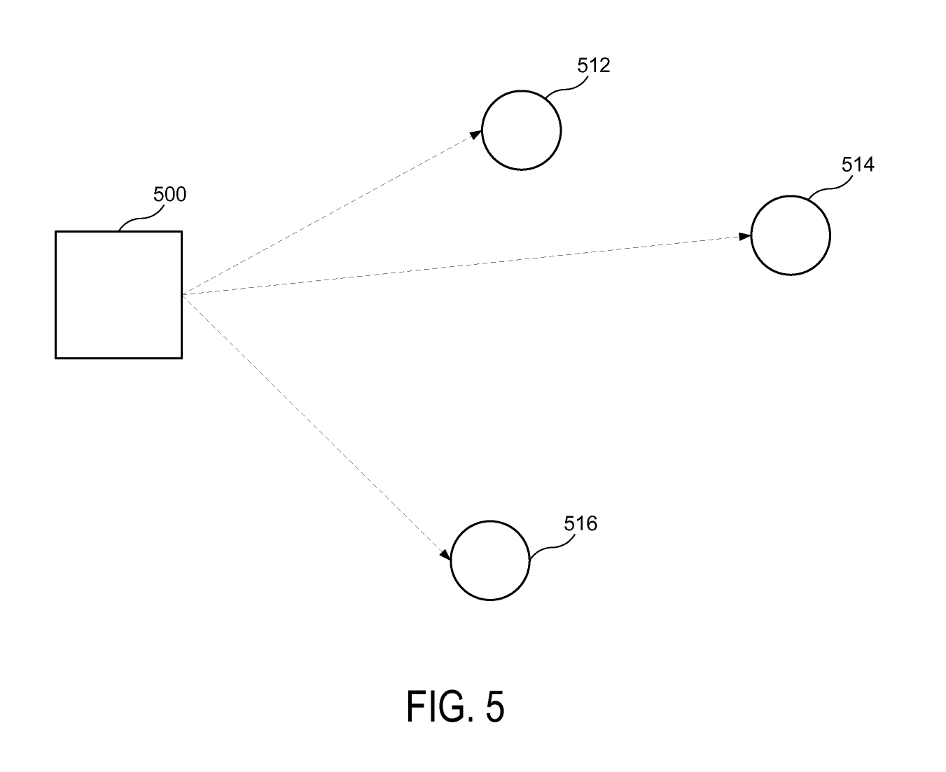

FIG. 5 depicts an exemplary transportation diagram that generally illustrates the delivery of a parcel 500 directly from a retailer to an alternate delivery location 512, 514, 516. As may be understood from this figure, parcel recipients may elect to have parcels delivered directly to alternate delivery locations 512, 514, 516. The parcel recipient may, for example, order one or more items from an online retailer and elect to have those one or more items shipped to one or more alternate delivery locations 512, 514, 516 rather than to a primary delivery location such as their home or office. In various embodiments, logistics companies or common carriers may limit the frequency with which they make deliveries to a particular alternate delivery location or for a particular parcel recipient. In such embodiments, the logistics company or common carrier may make no guarantee as to how much time it will take to ship the parcel to its ultimate destination as discussed above. In other embodiments, the parcel recipient (e.g., a customer placing one or more orders for one or more items from an online retailer), may select one or more different alternate delivery locations 512, 514, 516 based at least in part on an estimated (e.g., or guaranteed) delivery date determined by the system for each particular item ordered.

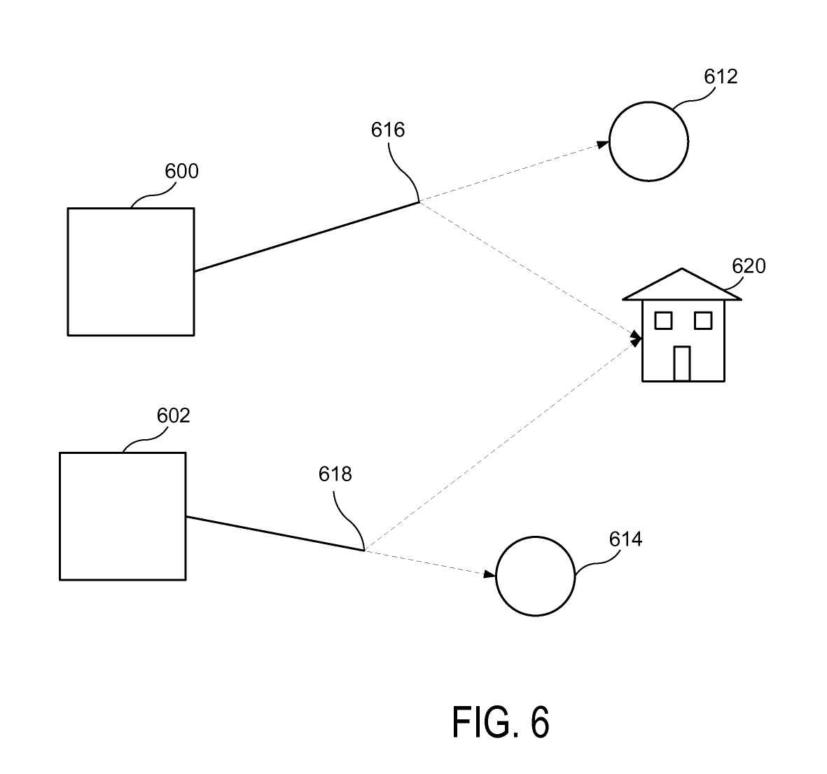

FIG. 6 depicts an exemplary transportation diagram that generally illustrates the redirection of one or more parcels 600, 602 from one or more alternate delivery locations 612, 614 to a primary delivery location 620 (e.g., the home of the intended recipient of the one or more parcels 600, 602). As may be understood from this diagram, the system is configured to redirect the one or more parcels 600, 602 in response to a request form the intended recipient, which may, for example, be received at 616 and 618 (e.g., at any suitable time or phase of delivery of the one or more parcels 600, 602 to the one or more alternate delivery locations 612, 614 such as while the one or more parcels 600, 602 are in transit, while the one or more parcels 600, 602 are held for delivery at a suitable holding facility, distribution center, etc.). The system, in various embodiments, may substantially automatically authenticate the individual requesting redirection of the one or more parcels 600, 602 as a person authorized to request the redirection. In such embodiments, the intended recipient may not be required to take any further action to redirect the one or more parcels 600, 602 to their primary delivery location 620 subsequent to placing the request.

### CONCLUSION

Many modifications and other embodiments of the invention will come to mind to one skilled in the art to which this invention pertains having the benefit of the teachings presented in the foregoing descriptions and the associated drawings. While examples discussed above cover the use of the invention in the context of a parcel redirection to a primary delivery location service, the invention may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

I claim:

1. A computer-implemented method of redirecting one or more parcels scheduled for delivery to one or more alternate delivery locations to a primary delivery location, comprising:
receiving, by a processor, an indication that one or more parcels are scheduled for delivery to one or more alternate delivery locations, the one or more parcels having an intended recipient;
at least partially in response to receiving the indication, notifying, by a processor, the intended parcel recipient of the one or more scheduled deliveries;
receiving from the intended parcel recipient, by a processor, a request to redirect at least one of the one or more parcels to a primary delivery location associated with the intended parcel recipient;
at least partially in response to receiving the request, determining, by a processor, whether the intended parcel recipient is authorized to redirect the at least one of the one or more parcels; and
at least partially in response to determining that the intended parcel recipient is authorized to redirect the at least one of the one or more parcels, substantially automatically facilitating, by a processor, redirection of the at least one of the one or more parcels from the one or more alternate delivery locations to the primary delivery location.

2. The computer-implemented method of claim 1, wherein the primary delivery location is selected from a group consisting of:
a residence of the intended parcel recipient; and
an office of the intended parcel recipient.

3. The computer-implemented method of claim 2, wherein:
the primary delivery location is the residence of the intended parcel recipient; and
determining whether the intended parcel recipient is authorized to redirect the at least one of the one or more parcels comprises substantially automatically determining that the intended parcel recipient is authorized based at least in part on receiving the request in reply to the notification of the one or more scheduled deliveries.

4. The computer-implemented method of claim 1, wherein:
receiving the request comprises receiving the request from an intended parcel recipient account associated with a common carrier; and
determining whether the intended parcel recipient is authorized to redirect the at least one of the one or more parcels comprises substantially automatically determining that the intended parcel recipient is authorized based at least in part on receiving the request from the intended parcel recipient account.

5. The computer-implemented method of claim 1, wherein:
receiving the request comprises receiving the request from a computing device associated with the intended parcel recipient; and
determining whether the intended parcel recipient is authorized to redirect the at least one of the one or more parcels comprises:
determining, by a processor, that the intended parcel recipient is substantially currently logged into the intended parcel recipient account on the computing device; and
at least partially in response to determining that the intended parcel recipient is substantially currently logged into the intended parcel recipient account on the computing device, determining that the intended parcel recipient is authorized.

6. The computer-implemented method of claim 1, wherein:
determining whether the intended parcel recipient is authorized to redirect the at least one of the one or more parcels comprises:
determining, by a processor, a source of the request;
at least partially in response to determining the source of the request, determining, by a processor, whether the source of the request is associated with the intended parcel recipient; and
at least partially in response to determining that the source of the request is associated with the intended parcel recipient, determining that the intended parcel recipient is authorized.

7. The computer-implemented method of claim 6, wherein:
the source of the request is a text message;
determining the source of the request comprises determining a phone number from which the text message was received; and
determining whether the source of the request is associated with the intended parcel recipient comprises determining whether the phone number is associated with the intended parcel recipient.

8. The computer-implemented method of claim 6, wherein:
the source of the request is an e-mail;
determining the source of the request comprises determining an e-mail address from which the e-mail was received; and
determining whether the source of the request is associated with the intended parcel recipient comprises determining whether the e-mail address is associated with the intended parcel recipient.

9. The computer-implemented method of claim 1, wherein:
the one or more parcels scheduled for delivery to the one or more alternate delivery locations comprise one or more items purchased by the intended parcel recipient as part of an order from an online retailer;
the computer-implemented method further comprises receiving, by a processor, information associated with the order, the information comprising authentication information associated with the intended parcel recipient; and
determining whether the intended parcel recipient is authorized to redirect the at least one of the one or more parcels comprises determining whether the intended parcel recipient is authorized based at least in part on the authentication information associated with the intended parcel recipient.

10. A non-transitory computer-readable medium storing computer executable instructions for:
receiving order information associated with an order for one or more items made by a user via an online retailer, the order information comprising authenticating information associated with the user;
receiving an indication that a parcel containing the one or more items is scheduled for delivery at an alternate delivery location;
at least partially in response to receiving the indication, notifying the user of the scheduled delivery;
receiving, from the user, a request to redirect the parcel to a primary delivery location;
at least partially in response to receiving the request, substantially automatically authenticating the request based at least in part on the authenticating information associated with the user; and
at least partially in response to substantially automatically authenticating the request, redirecting the parcel to the primary delivery location.

11. The non-transitory computer-readable medium of claim 10, wherein:
the order information comprises the primary delivery location;
the primary delivery location comprises a home address of the user.

12. The non-transitory computer-readable medium of claim 11, wherein the alternate delivery location is a location selected from the group consisting of:
i. a grocery store;
ii. a gas station;
iii. a locker bank; and
iv. a pharmacy.

13. The non-transitory computer-readable medium of claim 10, wherein:
the authentication information comprises a first IP address of a computing device from which the user placed the order; and
substantially automatically authenticating the request comprises:
determining a second IP address of a computing device from which the system received the request; and
determining whether the first IP address is the second IP address.

14. The non-transitory computer-readable medium of claim 10, wherein:
the authentication information comprises contact information associated with the user; and
substantially automatically authenticating the request comprises:
determining a source of the request; and
determining, based at least in part on the contact information, whether the source of the request is associated with the user.

15. The non-transitory computer-readable medium of claim 10, further storing computer-executable instructions for:
determining a cost to redirect the parcel; and
enabling the intended parcel recipient to provide payment to cover the cost.

16. The non-transitory computer-readable medium of claim 15, wherein determining the cost comprises determining the cost based at least in part on a distance between the alternate delivery location and the primary delivery location.

17. The non-transitory computer-readable medium of claim 10, wherein the primary delivery location is selected from a group consisting of:
a residence of the user; and
an office of the user.

18. A computer-implemented method of redirecting a parcel from an alternate delivery location to a primary delivery location, comprising:
receiving, by a processor, an indication that delivery of the parcel is not possible at the primary delivery location;
at least partially in response to receiving the indication, retrieving, by a processor, alternate delivery location information associated with the primary delivery location, the alternate delivery location information comprising information selected from a group consisting of:
i. one or more parcel recipient alternate delivery preferences; and
ii. one or more parcel shipper alternate delivery preferences;
determining, based at least in part on the alternate delivery location information, a suitable alternate delivery location;
redirecting, by a processor, the parcel from the primary delivery location to the suitable alternate delivery location;
notifying, by a processor, an intended parcel recipient of the redirection of the parcel to the suitable alternate delivery location;
at least partially in response to the notification, receiving, by a processor, a request from the intended parcel recipient to re-redirect the parcel to the primary delivery location;
at least partially in response to the request, substantially automatically authenticating the request; and
at least partially in response to substantially automatically authenticating the request, re-redirecting the parcel to the primary delivery location.

19. The computer-implemented method of claim 18, wherein substantially automatically authenticating the request comprises substantially automatically authenticating the request based at least in part on receiving the request in reply to the notification of the redirection of the parcel to the suitable alternate delivery location.

20. The computer-implemented method of claim 18, wherein:
receiving the request comprises receiving the request from an intended parcel recipient account associated with a common carrier; and
substantially automatically authenticating the request comprises substantially automatically authenticating the request based at least in part on receiving the request from the intended parcel recipient account.
